(19) United States
(12) Patent Application Publication
(10) Pub. No.: US 2020/0301952 A1
(43) Pub. Date: Sep. 24, 2020

(54) DOCUMENT SEARCH ASSIST APPARATUS AND NON-TRANSITORY COMPUTER READABLE MEDIUM, AND DOCUMENT SEARCH ASSIST SYSTEM

(71) Applicant: FUJI XEROX CO., LTD., Tokyo (JP)

(72) Inventor: Yasuhiro ITO, Kanagawa (JP)

(73) Assignee: FUJI XEROX CO., LTD., Tokyo (JP)

(21) Appl. No.: 16/556,165

(22) Filed: Aug. 29, 2019

(30) Foreign Application Priority Data
Mar. 19, 2019 (JP) 2019-051741

(51) Int. Cl. G06F 16/332; G06F 16/335; G06F 17/27; G06F 16/93

(52) U.S. Cl. CPC G06F 16/3326; G06F 16/337; G06F 16/93; G06F 17/2795; G06F 17/275

(57) ABSTRACT

A document search assist apparatus includes a language ability information acquisition unit, a search term input unit, and an assistance information presentation unit. The language ability information acquisition unit is configured to acquire information indicating a language ability of a searcher. The search term input unit is configured to receive a search term. The assistance information presentation unit is configured to present assistance information for input of the search term to the search term input unit, according to the language ability of the searcher, which is indicated by the information acquired by the language ability information acquisition unit.

### CROSS-REFERENCE TO RELATED APPLICATIONS

This application is based on and claims priority under 35 USC 119 from Japanese Patent Application No. 2019-051741 filed Mar. 19, 2019.

### BACKGROUND

### (i) Technical Field

The present disclosure relates to an apparatus for assisting document searching and a non-transitory computer readable medium, and a system for assisting the document searching.

### (ii) Related Art

JP-A-2017-204064 relates to apparatus for assisting users to read Japanese texts. JP-A-2017-204064 describes selecting a word difficulty level and displaying a translated term corresponding to a word having the selected difficulty level from among words in a Japanese original text.

JP-A-2000-112948 relates to a Japanese language search apparatus. JP-A-2000-112948 describes that when a searcher inputs an English keyword, the input English keyword is translated into plural Japanese keywords, and the searcher selects one of the plural translated Japanese keywords, and a document is searched for according to the selected Japanese keyword.

### SUMMARY

When a searcher, such as a foreign resident, who does not a high language ability searches a document using a document search apparatus, it may be difficult for him/her to input a search term for searching for a target document.

Aspects of non-limiting embodiments of the present disclosure relate to providing a document search assist apparatus and a non-transitory compute readable medium that are capable of assisting a searcher who does not have a high language ability to input a search term for searching for a target document, and a document search assist system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a document search assist apparatus including: a language ability information acquisition unit configured to acquire information indicating a language ability of a searcher; a search term input unit configured to receive a search term; and an assistance information presentation unit configured to present assistance information for input of the search term to the search term input unit, according to the language ability of the searcher, which is indicated by the information acquired by the language ability information acquisition unit.

### BRIEF DESCRIPTION OF THE DRAWINGS

Exemplary embodiment(s) of the present disclosure will be described in detail based on the following figures, wherein:

FIG. 1 is a view illustrating a configuration according to an exemplary embodiment of a technology of the present disclosure;

FIG. 2 is a block diagram illustrating a hardware configuration of a document search assist apparatus;

FIG. 3 is a block diagram illustrating an example of functional components of the document search assist apparatus;

FIGS. 4A and 4B are views each illustrating an example of a screen through which information indicating a Japanese language ability of a searcher is registered, on a display screen of a display device;

FIG. 5 is a view illustrating an example of a screen through which the information indicating the Japanese language ability of the searcher is registered, on the display screen of the display device;

FIG. 6 is a view illustrating an example of a screen through which work information of the searcher is registered, on the display screen of the display device;

FIGS. 7A and 7B are views each of which illustrates the document search results in each of a process at a time of construction start and a process at a time of construction execution, on a work;

FIGS. 8A and 8B are views each illustrating the document search results in each of a process at a time of construction completion and a process after construction completion, on the work;

FIG. 9 is a view illustrating technical terms defined in the process at the time of construction start, the process at the time of construction execution, the process at the time of construction completion, and the process after the construction completion, together with work-specific terms;

FIGS. 10A and 10B are views illustrating an example in which the searcher (user) registers a technical term and a work-specific term;

FIG. 11 is a view illustrating a text box displayed on the display screen of the display device;

FIGS. 12A to 12C are views each of which illustrates an example in which assistance information is presented on a search term input unit;

FIGS. 13A to 13C are views each of which illustrates an example in which the assistance information is presented on the search term input unit;

FIGS. 14A to 14C are views each of which illustrates an example in which the assistance information is presented on the search term input unit;

FIGS. 15A to 15C are views each of which illustrates an example in which the assistance information for facilitating understanding of a search term input to the search term input unit is presented according to a language ability of the searcher;

FIGS. 16A and 16B are views each of which illustrates an example in which assistance information related to the search term input to the search term input unit is displayed according to the language ability of the searcher;

FIGS. 17A to 17C are views each of which illustrates a configuration example in which the assistance information is displayed in a selectable manner as a term related to the search term;

FIG. 18 is a view illustrating a relationship between a Japanese language test passing grade and assistance;

FIG. 19 is a view illustrating a relationship between items determined in a Japanese language test and assistance;

FIGS. 20A and 20B are views each of which illustrates an example in which the assistance information is changed according to a work of the searcher as a term related to the search term;

FIG. 21 is a flowchart illustrating an example of a process procedure according to the exemplary embodiment;

FIG. 22 is a flowchart illustrating another example of the process procedure according to the exemplary embodiment; and

FIG. 23 is a view illustrating a generation process of the assistance information related to the search term.

### DETAILED DESCRIPTION

Hereinafter, an example of an exemplary embodiment of a technology of the present disclosure will be described with reference to the accompanying drawings. In the respective drawings, the same or equivalent elements and portions are given the same reference numerals. Further, the dimensional proportions in the drawings are exaggerated for the convenience of description and may be different from actual proportions.

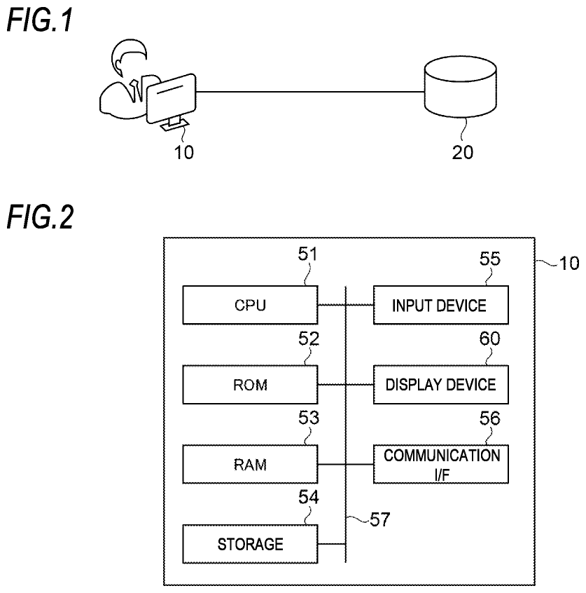

FIG. 1 is a view illustrating a configuration according to an exemplary embodiment of a technology of the present disclosure.

As illustrated in FIG. 1, a document search assist apparatus 10 is implemented by, for example, a user terminal device. The document search assist apparatus 10 is connected to a database 20 and is able to communicate with the database 20. The document search assist apparatus 10 assists a user who needs to search in a language other than a native language such that the user can search data stored in the database 20.

FIG. 2 is a block diagram illustrating a hardware configuration of the document search assist apparatus 10.

As illustrated in FIG. 2, the document search assist apparatus 10 includes components such as a central processing unit (CPU) 51, a read only memory (ROM) 52, a random access memory (RAM) 53, a storage 54, an input device 55, a display device 60, and a communication interface (communication I/F) 56. The components are connected to communicate with each other via a bus 57.

The CPU 51 is a central arithmetic processing unit, and executes various programs and controls the respective units. That is, the CPU 51 reads a program from the ROM 52 or the storage 54, and executes the program using the RAM 53 as a work area. The CPU 51 controls the components described above and performs various arithmetic processes according to the program stored in the ROM 52 or the storage 54. In the present exemplary embodiment, a document search assist program is stored in the ROM 52 or the storage 54.

The ROM 52 stores various programs and various data. The RAM 53 serves as a work area and temporarily stores programs or data. The storage 54 is implemented by a hard disk drive (HDD) or a solid state drive (SSD), and stores various programs including an operating system, and various data.

The input device 55 includes a pointing device such as a mouse, and a keyboard, and is used to perform various inputs. The display device 60 is, for example, a liquid crystal display, and displays various information. The display device 60 may function as the input device 55 by employing a touch panel type device.

The communication interface 56 is an interface for communicating with other devices such as the database 20, and employs standards such as, for example, Ethernet (registered trademark), FDDI, and Wi-Fi (registered trademark).

In a language ability information storage of the database 20, information indicating a Japanese language ability is stored in association with each user (each searcher).

In a work information storage of the database 20, work information is stored in association with each user (each searcher).

In a document storage of the database 20, documents to be searched are stored.

Next, functional components of the document search assist apparatus 10 will be described.

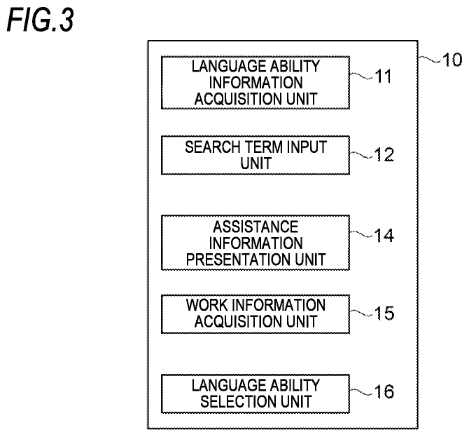

FIG. 3 is a block diagram illustrating an example of functional components of the document search assist apparatus 10.

As illustrated in FIG. 3, the document search assist apparatus 10 includes a language ability information acquisition unit 11, a search term input unit 12, an assistance information presentation unit 14, a work information acquisition unit 15, and a language ability selection unit 16, as functional components.

Each functional component is implemented by the CPU 51 reading the document search assist program stored in the ROM 52 or the storage 54 and loading and executing the document search result presentation program on the RAM 53.

The process of the document search assist program may also be implemented by a dedicated hardware circuit. In this case, the document search assist program may be executed by a single hardware circuit or plural hardware circuits.

In addition, a program that operates the document search assist apparatus 10 may be provided by a computer readable recording medium such as a universal serial bus (USB) memory, a flexible disc, or a compact disc read only memory (CD-ROM), or may be provided on-line via a network such as the Internet. In this case, the program recorded in the computer readable recording medium is generally transmitted to a memory, a storage, or the like and is stored. In addition, the program may be provided as, for example, single application software, or may be embedded as one function of the document search assist apparatus 10 in software of the apparatus.

The respective elements of the document search assist apparatus 10 will be described below.

The language ability information acquisition unit 11 reads information indicating a language ability associated with a searcher from the language ability information storage of the database 20, and acquires the information indicating the language ability of the searcher.

A search term is input to the search term input unit 12 according to an input operation of the searcher.

That is, the search term input unit 12 receives the search term.

The assistance information presentation unit 14 presents assistance information for input of a search term to the search term input unit 12, according to the language ability of the searcher, which is indicated by the information acquired by the language ability information acquisition unit 11.

For example, when the searcher has the language ability at a level where one understands hiragana characters, the assistance information is displayed in a display format in which Kanji characters in the assistance information are converted into hiragana characters. For example, when the searcher has the language ability at a level where one understands Roman characters, the assistance information is displayed in a display format in which Kanji-Kana mixed sentences in the assistance information are converted into Roman characters. For example, when the searcher has the language ability at a level where one understands easy-to-understand Japanese, the assistance information is displayed in a display format in which Japanese texts in the assistance information are converted into easy-to-understand Japanese.

In addition, when a search term is input to the search term input unit 12, the assistance information presentation unit 14 presents a term related to the search term, as the assistance information, according to the language ability of the searcher, which is indicated by the information acquired by the language ability information acquisition unit 11.

Further, the assistance information presentation unit 14 presents terms related to the search term according to a work of the searcher that is indicated by information acquired by the work information acquisition unit 15 (which will be described later).

Further, the assistance information presentation unit 14 presents a term related to the work of the searcher, which is indicated by the information acquired by the work information acquisition unit 15, among terms included in the assistance information related to the search term, in a presentation format corresponding to a language ability higher than the language ability of the searcher, which is indicated by the information acquired by the language ability information acquisition unit 11. For example, even for a searcher having a low Japanese language ability, terms that are used in the work among the terms included in the assistance information are displayed in a display format (for example, Kanji characters) corresponding to the highest language ability.

Further, the assistance information presentation unit 14 presents a term related to a past work, which is indicated by the information acquired by the work information acquisition unit 15, among the terms included in the assistance information related to the search term, in a presentation format corresponding to a language ability higher than the language ability of the searcher, which is indicated by the information acquired by the language ability information acquisition unit 11.

Further, the assistance information presentation unit 14 presents the assistance information related to the search term such that the longer a time period for which the searcher is involved in a work is or the more the number of times the searcher experiences the work is, the more words are presented in the presentation format corresponding to the language ability higher than the language ability of the searcher, which is indicated by the information acquired by the language ability information acquisition unit 11.

Further, the assistance information presentation unit 14 presents a term related to a file stored by the searcher, which is indicated by the information acquired by the work information acquisition unit 15, among the terms included in the assistance information related to the search term, in the presentation format corresponding to the language ability higher than the language ability of the searcher, which is indicated by the information acquired by the language ability information acquisition unit 11.

Further, the assistance information presentation unit 14 presents the assistance information to the search term input unit 12, according to the language ability of the searcher, which is indicated by the information acquired by the language ability information acquisition unit 11.

The work information acquisition unit 15 reads work information associated with the searcher from the work information storage of the database 20 and acquires information indicating a work of the searcher. The information indicating the work of the searcher is information on past works in which the searcher is involved, information on a time period for which the searcher is involved in the work, information on the number of times the searcher experiences the work, information on a file stored by the searcher, or the like.

The language ability selection unit 16 selects the language ability of the searcher according to an operation of the searcher.

In this case, the assistance information presentation unit 14 presents the assistance information to the search term input unit 12, according to the language ability of the searcher, which is selected by the language ability selection unit 16.

### (Acquire Information Indicating Language Ability)

An example of the language ability information acquisition unit 11 will be described below.

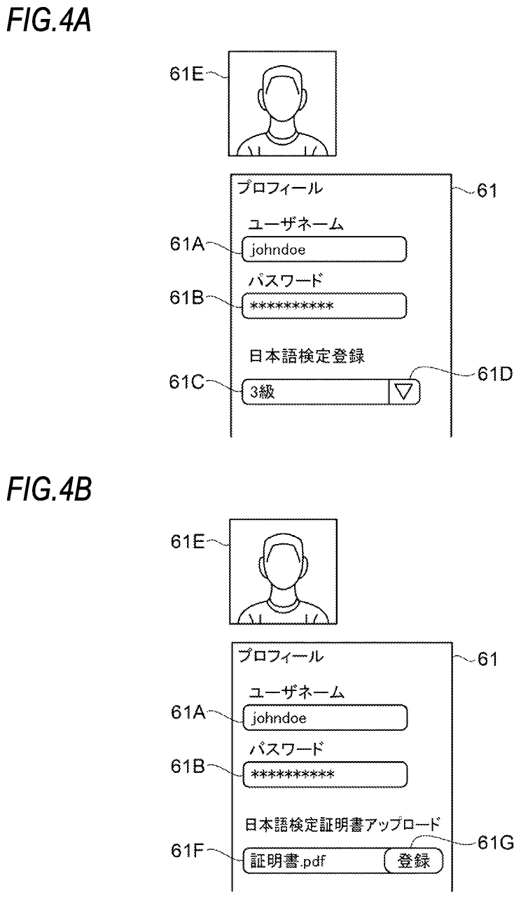

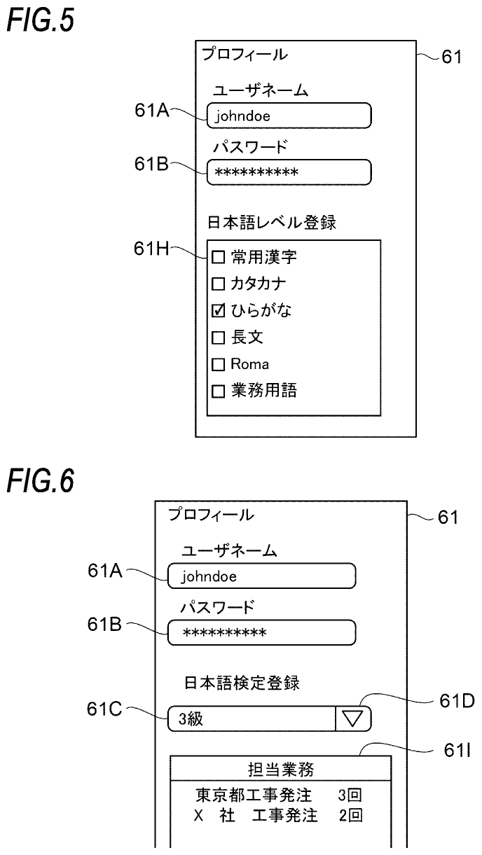

Each of FIGS. 4A, 4B, and 5 illustrates an example of a configuration of screens through which information indicating the Japanese language ability of the searcher is registered, on a display screen of the display device 60.

FIG. 4A illustrates a configuration example of a screen through which information indicating the Japanese language ability of the searcher is registered by performing an operation of inputting a Japanese language test passing grade of the searcher.

As illustrated in FIG. 4A, a user information registration screen 61 is displayed on the display screen of the display device 60.

On the user information registration screen 61, a text box 61A for inputting a user name, a text box 61B for inputting a password, and a drop down box 61C for inputting a Japanese language test passing grade are arranged.

The searcher inputs a name of the searcher (for example, “johndoe”), as a user name, to the text box 61A. The searcher inputs a password of the searcher to the text box 61B. The searcher inputs the Japanese language test passing grade (for example, “3 [symbol] ”) to the drop down box 61C. When an operation of instructing a mark 61D for displaying a drop down list is performed, a list of Japanese language test passing grades “1 [symbol] ”, “ [symbol] 1 [symbol] ”, “ [symbol] 2”, “ [symbol] 2 [symbol] ”, “3 [symbol] ”, “ [symbol] 3 [symbol] ”, “4 [symbol] ”, and “ [symbol] 4 [symbol] ” is displayed as the drop down list. The searcher performs an operation of selecting his/her Japanese language test passing grade (for example, “3 [symbol] ”) from the drop down list. Accordingly, the Japanese language test passing grade (for example, “3 [symbol] ”) of the searcher is input to the drop down box 61C.

The input name (for example, “johndoe”) of the searcher, the password of the searcher, and the Japanese language test passing grade (for example, “3 [symbol] ”) of the searcher are stored in the language ability information storage of the database 20 in association with each other.

The language ability information acquisition unit 11 reads the information indicating the language ability (for example, the Japanese language test passing grade is “3 [symbol] ”) associated with the searcher (for example, “johndoe”) from the language ability information storage of the database 20, and acquires the information indicating the language ability (for example, the Japanese language test passing grade is “3 [symbol] ”) of the searcher (for example, “johndoe”).

In addition, a face photo input unit 61E may be provided on the display screen of the display device 60, and a process of registering the searcher (for example, “johndoe”) in association with a face photo of the searcher may be performed.

The information indicating the Japanese language ability of the searcher may be registered by uploading a test result certificate of a Japanese language test, instead of inputting the Japanese language test passing grade.

FIG. 4B illustrates an example of a configuration of a screen through which the information indicating the Japanese language ability of the searcher is registered by performing an operation of uploading the test result certificate of the Japanese language test of the searcher.

The same elements as those in FIG. 4A will be denoted by the same reference numerals as those in FIG. 4A, and descriptions thereof will be omitted. Then, portions different from those in FIG. 4A will be described.

On the user information registration screen 61, a box 61F for uploading the test result certificate of the Japanese language test is provided.

The searcher inputs a file of the test result certificate of the Japanese language test (for example, “ [symbol] .pdf”), to the box 61F. The file of the test result certificate of the Japanese language test may be selected from a drop down list, and then input. When the file of the test result certificate of the Japanese language test (for example, “ [symbol] .pdf”) is input to the box 61F, the searcher performs an operation of pressing a button 61G for registering the file of the test result certificate of the Japanese language test.

Accordingly, the input name of the searcher (for example, “johndoe”), the password of the searcher, and information stored in the file of the test result certificate of the Japanese language test of the searcher (for example, the test result of the Japanese language test is “3 [symbol] ”) are stored in the language ability information storage of the database 20 in association with each other.

The language ability information acquisition unit 11 reads the information indicating the language ability (for example, the test result of the Japanese language test is “3 [symbol] ”) associated with the searcher (for example, “johndoe”) from the language ability information storage of the database 20, and acquires the information indicating the language ability (for example, the test result of the Japanese language test is “3 [symbol] ”) of the searcher (for example, “johndoe”).

The searcher may select his/her Japanese ability level among selection options, to thereby register the information indicating the Japanese language ability of the searcher.

FIG. 5 illustrates an example of a configuration of a screen through which the information indicating the Japanese language ability of the searcher is registered by the searcher performing an operation of selecting his Japanese ability level.

As illustrated in FIG. 5, the user information registration screen 61 is displayed on the display screen of the display device 60. The same elements as those in FIGS. 4A and 4B will be denoted by the same reference numerals as those in FIGS. 4A and 4B and descriptions thereof will be omitted. Then, portions different from those in FIGS. 4A and 4B will be described.

On the user information registration screen 61, a check box 61H for registering the Japanese ability level of the user (searcher) is provided.

The searcher performs an operation of giving a check to an item that he/she understands, among items “ [symbol] ”, “ [symbol] ”, “ [symbol] ”, “ [symbol] ”, “Roma ( [symbol] [symbol] )”, and “ [symbol] ” in the check box 61H. The searcher may perform an operation of giving checks to plural items.

For example, when the searcher determines that he/she is at a level where one understands “ [symbol] ”, a check is given to “ [symbol] ” in the check box 61H.

Accordingly, the input name of the searcher (for example, “johndoe”), the password of the searcher, and the Japanese ability level of the searcher (for example, “understand ‘ [symbol] [symbol] ’”) are stored in the language ability information storage of the database 20 in association with each other.

The language ability information acquisition unit 11 reads the information indicating the language ability (for example, “understand ‘ [symbol] ’”) associated with the searcher (for example, “johndoe”) from the language ability information storage of the database 20, and acquires the information indicating the language ability (for example, “understand ‘ [symbol] [symbol] ’”) of the searcher (for example, “johndoe”).

The Japanese language test result may be registered in detail. A language ability level may be registered for each of items, for example, “honorific”, “grammar”, “vocabulary”, “meaning of words”, “notation”, and “Kanji characters”.

As the information indicating the language ability, information on a speaking ability level, a writing ability level, and a listening ability level may be registered.

In addition, information indicating that the searcher is at a level where one understands the native language of the searcher may be registered.

### (Acquire Information Indicating Work)

An example of the work information acquisition unit 15 will be described.

In the work information storage of the database 20, work information is stored in association with each user (each searcher). The work information includes information on past works in which the searcher is involved (a history of works which are assigned to the searcher), information on a process of a work being currently performed by the searcher (information on the progress degree of a process being currently performed), technical terms defined in each process, work-specific terms, information on files stored in the past, a time period for which the searcher is involved in the work, the number of times the searcher experiences the work, and the like.

The work information is stored for each user in the work information storage of the database 20 by performing a process of registering the work information is performed for each user on the display screen of the display device 60. Information indicating the work of the searcher is acquired by the work information acquisition unit 15 reading the work information associated with the searcher from the work information storage of the database 20.

FIG. 6 illustrates an example of a screen through which the work information of the searcher is registered, on the display screen of the display device 60. The information on the past works in which the searcher is involved (the history of works which are assigned to the searcher) is registered as the work information of the searcher.

As illustrated in FIG. 6, the user information registration screen 61 is displayed on the display screen of the display device 60. The same elements as those in FIGS. 4A, 4B, and 5 will be denoted by the same reference numerals as those in FIGS. 4A, 4B, and 5, and descriptions thereof will be omitted. Then, portions different from those in FIGS. 4A, 4B, and 5 will be described.

The searcher inputs a history of works which are assigned to the searcher (for example, “ [symbol] 3 [symbol] ”, or “ [symbol] 2 [symbol] ”), to a text box 61I for inputting a history of works which are assigned to the searcher.

The input name of the searcher (for example, “johndoe”), the password of the searcher (for example, “********”, and the history of works which are assigned to the searcher (for example, “ [symbol] 3 [symbol] ”, or “ [symbol] 2 [symbol] ”) are stored in the work information storage of the database 20 in association with each other.

In this manner, the information on the number of time the searcher experiences the works is registered.

Likewise, the information on the time period for which the searcher is involved in the work may be registered on the display screen.

Next, descriptions will be made on an example in which technical terms defined in each process of a work and work-specific terms are registered.

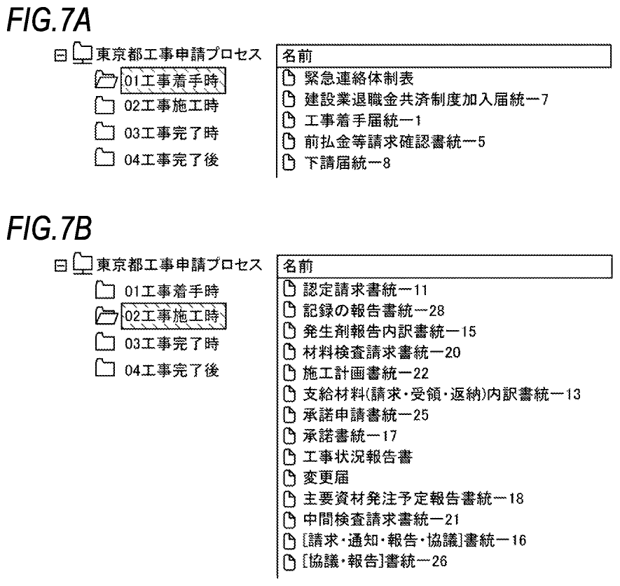

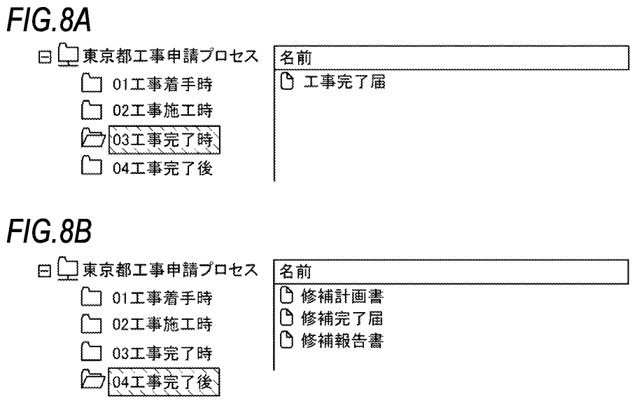

Each of FIGS. 7A, 7B, 8A, and 8B illustrates document search results in each process at a time of construction start, at a time of construction execution, at a time of construction completion, and after construction completion, on a work that Tokyo construction application.

The database 20 stores documents in association with each process of the work. Therefore, as illustrated in FIGS. 7A, 7B, 8A, and 8B, when a process of the work is selected on a search screen, a list of documents related to the selected process is displayed on the display device 60.

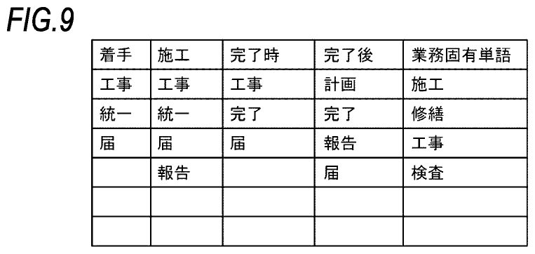

FIG. 9 is a view illustrating technical terms defined in the process at the time of construction start, the process at the time of construction execution, the process at the time of construction completion, and the process after the construction completion, together with work-specific terms.

For example, at the time of construction start, “ [symbol] ”, “ [symbol] ”, and “ [symbol] ” are technical terms (frequently-appearing terms) defined in the process. Further, “ [symbol] ”, “ [symbol] ”, “ [symbol] ”, and “ [symbol] ” are the work-specific terms.

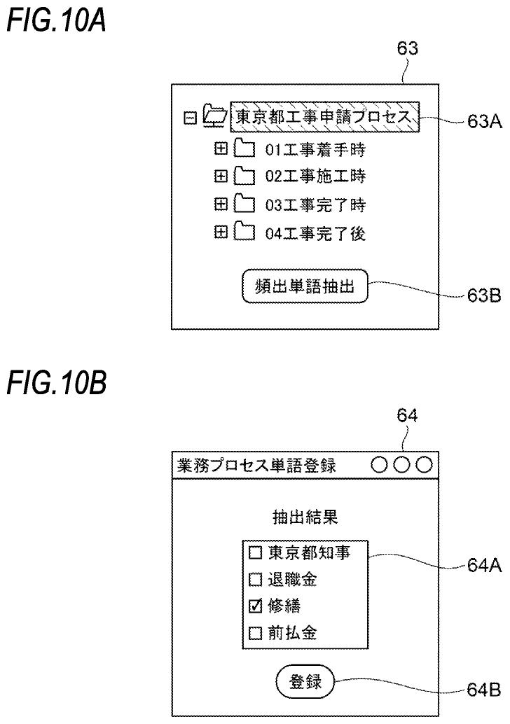

FIGS. 10A and 10B illustrate an example in which the searcher (user) registers a technical term and a work-specific term.

As illustrated in FIG. 10A, a work process word registration screen 63 is displayed on the display screen of the display device 60.

On the work process word registration screen 63, each folder group that stores documents for each work and for each process of the each work is displayed, and further, a button 63B is displayed.

The searcher performs an operation of designating a desired folder (for example, a folder 63A of the work “ [symbol] [symbol] ”), and performs an operation of pressing the button 63B. Then, the work process word registration screen 63 in FIG. 10A transitions to a work process word registration screen 64 illustrated in FIG. 10B.

Technical terms frequently appearing in documents stored in the designated folder (for example, the folder 63A of the work “ [symbol] [symbol] ”) and work-specific terms (for example, terms specific to the work “ [symbol] [symbol] ”) are extracted and displayed on the work process word registration screen 64. A check is given to a frequently-appearing term which the searcher wants to register (for example, “ [symbol] ”) among the frequently-appearing terms displayed in a check box 64A, and an operation of pressing a button 64B is performed. Then, the frequently-appearing term (for example, “ [symbol] ”) is registered in association with the process, as illustrated in FIG. 9.

The searcher (user) may register technical terms and work-specific terms by performing an operation of inputting the technical terms and the work-specific terms on the display screen of the display device 60.

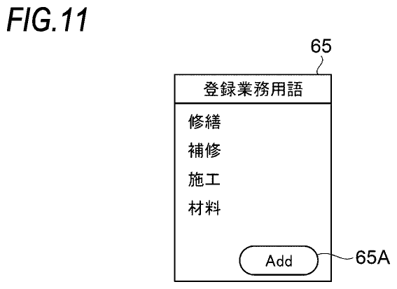

In this case, as illustrated in FIG. 11, a text box 65 may be displayed on the display screen of the display device 60.

The searcher (user) performs an operation of inputting technical terms and work-specific terms (for example, work-specific terms such as “ [symbol] ”, “ [symbol] ”, “ [symbol] ”, and “ [symbol] ”) to the text box 65. Then, the searcher (user) performs an operation of pressing a button 65A. Then, the input words (for example, the work-specific terms such as “ [symbol] ”, “ [symbol] ”, “ [symbol] ”, and “ [symbol] ”) are registered in association with the process as illustrated in FIG. 9.

The searcher may register words used in a file name used in a past work.

For example, by performing an operation of designating file illustrated in FIGS. 7A, 7B, 8A, and 8B, terms used in the designated file name may be registered in association with the process as illustrated in FIG. 9.

As described above, the searcher performs the registration process on the display screen of the display device 60, so that the work information of the searcher is stored in the work information storage of the database 20.

The work information may be automatically stored in the work information storage of the database 20.

For example, by the searcher performing an operation of storing a file, terms used in the stored file name may be automatically stored in the work information storage of the database 20 as terms to be displayed in a display format (for example, Kanji characters) corresponding to a language ability higher than the language ability of the searcher (for example, the highest language ability).

### (Assistance Information Presentation Unit and Language Ability Selection Unit)

Descriptions will be made on an example of the assistance information presentation unit 14 and the language ability selection unit 16.

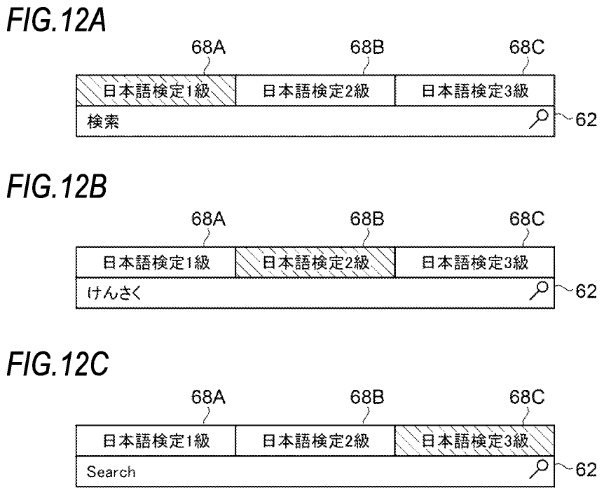

Each of FIGS. 12A to 12C illustrates an example of a configuration of the assistance information presentation unit 14 that displays assistance information on the search term input unit 12, according to a language ability of the searcher.

As illustrated in FIGS. 12A to 12C, the search term input unit 12 includes a search box 62. The search box 62 is displayed on the display screen of the display device 60. A button 68A for selecting a first grade of the Japanese language test, a button 68B for selecting a second grade of the Japanese language test, and a button 68C for selecting a third grade of the Japanese language test are provided in the vicinity of the search box 62. The buttons 68A, 68B, and 68C constitute the language ability selection unit 16. By pressing the button 68A, 68B, or 68C, an assistance level for input of a search term is selected.

As illustrated in FIG. 12A, when the Japanese language test passing grade registered by the searcher in advance is the first grade, information for assisting input of a search term is displayed in the search box 62 according to the first grade of the Japanese language test (for example, “ [symbol] ” is displayed in Kanji characters).

As illustrated in FIG. 12B, when the Japanese language test passing grade registered by the searcher in advance is the second grade, the information for assisting input of a search term is displayed in the search box 62 according to the second grade of the Japanese language test (for example, “ [symbol] ” is displayed in hiragana characters).

As illustrated in FIG. 12C, when the Japanese language test passing grade registered by the searcher in advance is the third grade, the information for assisting input of a search term is displayed in the search box 62 according to the third grade of the Japanese language test (for example, “Search” is displayed in the native language of the operator).

As described above, the assistance information is displayed in the search box 62 at the level corresponding to the language ability registered by the searcher in advance.

In addition, in FIGS. 12A to 12C, when the searcher performs an operation of selecting any of the button 68A, 68B, and 68C, the assistance information is displayed in the search box 62 at the level corresponding to the selected language ability. This enables to manually select the assistance level for input of a search term.

The amount of assistance information may be changed according to the language ability of the searcher.

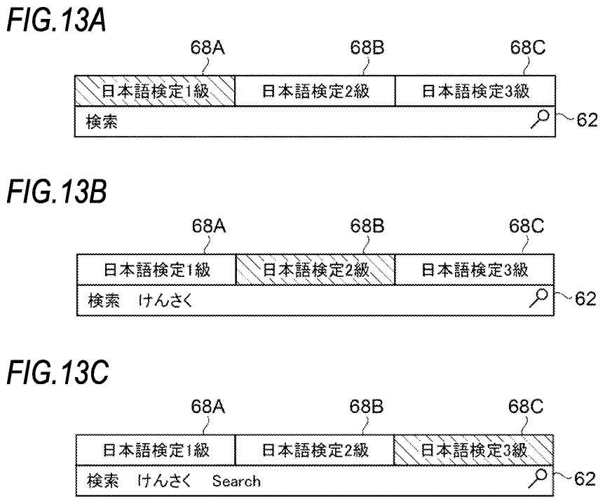

Similarly to FIGS. 12A to 12C, FIGS. 13A to 13C each illustrates an example in which the assistance information is displayed in the search term input unit 12 provided with the search box 62, according to the language ability of the searcher.

As illustrated in FIG. 13A, when the Japanese language test passing grade registered by the searcher in advance is the first grade, the information for assisting input of a search term is displayed in the search box 62 according to the first grade of the Japanese language test (for example, “ [symbol] ” is displayed only in Kanji characters).

As illustrated in FIG. 13B, when the Japanese language test passing grade registered by the searcher in advance is the second grade, the information for assisting input of a search term is displayed in a large amount in the search box 62 as compared with the information amount illustrated in FIG. 13A. For example, two pieces of information, that is, “ [symbol] ” in Kanji characters and “ [symbol] ” in hiragana characters are displayed.

As illustrated in FIG. 13C, when the Japanese language test passing grade registered by the searcher in advance is the third grade, information for assisting input of a search term is displayed in a large amount in the search box 62 as compared with the information amount illustrated in FIG. 13B. For example, three pieces of information, that is, “ [symbol] ” in Kanji characters, “ [symbol] ” in hiragana characters, and “Search” in the native language of the searcher are displayed.

As described above, the assistance information is displayed in the search box 62 at the level corresponding to the language ability registered by the searcher in advance and in the information amount corresponding to the language ability registered by the searcher in advance.

In addition, in FIGS. 13A to 13C, when the searcher performs an operation of selecting any of the button 68A, 68B, and 68C, the assistance information is displayed in the search box 62 at the level corresponding to the selected language ability and in the information amount corresponding to the selected language ability. This enables to manually select the assistance level for input of a search term and an information amount for assisting input of a search term.

Instead of selecting the language ability stepwise by an operation of pressing a button, the language ability may be selected stepwise by an operation of moving a slider.

Similarly to FIGS. 12A to 12C and 13A to 13C, FIGS. 14A to 14C each illustrates an example in which the assistance information is displayed in the search term input unit 12 provided with the search box 62 according to the language ability of the searcher.

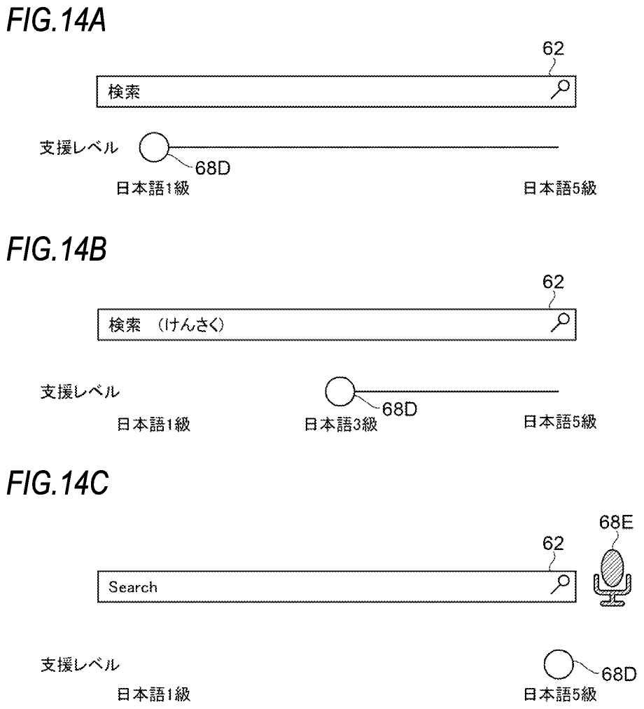

As illustrated in FIGS. 14A to 14C, the search term input unit 12 includes the search box 62. The search box 62 is provided on the display screen of the display device 60. A slider 68D for selecting the first grade to the fifth grade of the Japanese language test is provided in the vicinity of the search box 62. The slider 68D constitutes the language ability selection unit 16. By moving the slider 68D, the assistance level for input of a search term is selected.

As illustrated in FIG. 14A, when the Japanese language test passing grade registered by the searcher in advance is the first grade, the information for assisting input of a search term is displayed in the search box 62, for example, “ [symbol] ” is displayed in Kanji characters.

As illustrated in FIG. 14B, when the Japanese language test passing grade registered by the searcher in advance is the third grade, the information for assisting input of a search term is displayed in the search box 62, for example, “ [symbol] )” (Kanji characters with furigana in hiragana characters) is displayed. Furigana is characters (for example, hiragana characters) indicating the pronunciation of Kanji characters.

As illustrated in FIG. 14C, when the Japanese language test passing grade registered by the searcher in advance is the fifth grade, the information for assisting input of a search term is displayed in the search box 62, for example, “Search” is displayed in the native language of the operator. A voice input button 68E for selecting voice input is displayed in the vicinity of the search box 62. The voice input button 68E constitutes the assistance information. By performing an operation of pressing the voice input button 68E, a search term may be input by voice from a microphone (not illustrated).

As described above, the assistance information is displayed in the search box 62 at the level corresponding to the language ability registered by the searcher in advance.

In addition, in FIGS. 14A to 14C, when the searcher performs an operation of moving the slider 68D to any selected position, the assistance information is displayed in the search box 62 at the level corresponding to the selected language ability. This enables to manually select the assistance level for input of a search term.

FIGS. 12A to 14C are the examples of the assistance information displayed in the search term input unit 12. The assistance information is not limited to characters for assisting input of a search term or buttons such as the voice input button 68E. The assistance information may be an icon for assisting input of a search term. The number of icons and the shapes of icons may be changed according to the language ability of the searcher. For example, an icon corresponding to the native language of the searcher may be displayed.

The assistance information for facilitating understanding of a search term input to the search term input unit 12 may be presented by, for example, voice.

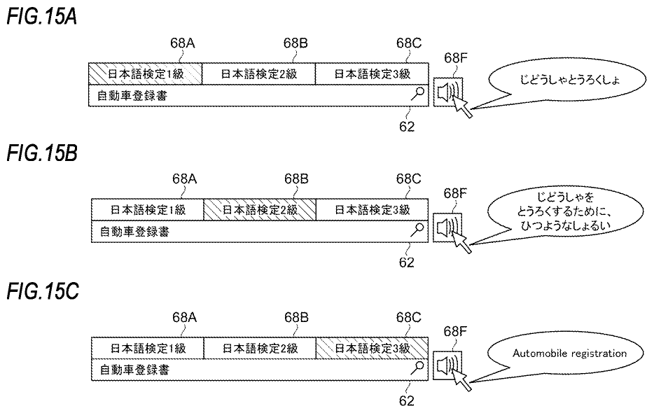

FIGS. 15A to 15C each illustrates an example in which assistance information for facilitating understanding of a search term input to the search term input unit 12 is presented by voice according to the language ability of the searcher.

As illustrated in FIGS. 15A to 15C, the search term input unit 12 includes the search box 62. The search box 62 is provided on the display screen of the display device 60. The button 68A for selecting the first grade of the Japanese language test, the button 68B for selecting the second grade of the Japanese language test, and the button 68C for selecting the third grade of the Japanese language test are provided in the vicinity of the search box 62. The buttons 68A, 68B, and 68C constitute the language ability selection unit 16. By pressing the button 68A, 68B, or 68C, an assistance level required for understanding a search term input to the search term input unit 12 is selected. A voice output button 68F is displayed in the vicinity of the search box 62. By performing an operation of pressing the voice output button 68F, the assistance information for facilitating understanding of a search term input to the search box 62 is read aloud at the selected assistance level by a speaker (not illustrated).

As illustrated in FIG. 15A, when the Japanese language test passing grade registered by the searcher in advance is the first grade, a search term in the search box 62 is read aloud as it is written in response to an operation of pressing the voice output button 68F.

As illustrated in FIG. 15B, when the Japanese language test passing grade registered by the searcher in advance is the second grade, a commentary of the search term is read aloud in response to the operation of pressing the voice output button 68F.

As illustrated in FIG. 15C, when the Japanese language test passing grade registered by the searcher in advance is the third grade, the search term in the search box 62 is read aloud in the native language through translation in response to the operation of pressing the voice output button 68F.

In addition, in FIGS. 15A to 15C, when the searcher performs the operation of selecting the button 68A, 68B, or 68C, and performs the operation of pressing the voice output button 68F, the assistance information for facilitating understanding of a search term in the search box 62 is read aloud at the selected assistance level. This enables to manually select an assistance level for facilitating understanding of a search term.

When the search term is input to the search term input unit 12, the assistance information presentation unit 14 may present assistance information related to the search term according to the language ability of the searcher.

The assistance information related to the search term is, for example, a word by which a target document can be retrieved. The word by which the target document can be retrieved is obtained by analogy with the search term input by the searcher to the search term input unit 12.

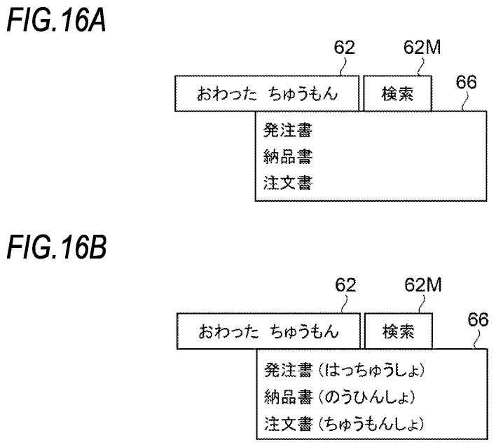

FIGS. 16A and 16B each illustrates an example of a configuration of the assistance information presentation unit 14 that displays assistance information related to a search term input to the search term input unit 12 according to the language ability of the searcher.

As illustrated in FIGS. 16A and 16B, the search term input unit 12 includes the search box 62. The search box 62 is provided on the display screen of the display device 60. A display unit 66 that displays the assistance information related to the search term is provided in the vicinity of the search box 62.

It is assumed that a search term “ [symbol] [symbol] ” is input to the search box 62.

Then, as illustrated in FIG. 16A, terms related to the search term are displayed in the display unit 66 as assistance information. Here, when the Japanese language test passing grade registered by the searcher in advance is the second grade, for example, the related terms are displayed in only Kanji characters. The terms related to the search term are obtained by analogy with the input “ [symbol] [symbol] ”. For example, among document names stored in the database 20, document names highly related to “ [symbol] [symbol] ” may be displayed as recommendations of the search term through analogy by natural language processing. In FIG. 16A, “ [symbol] ”, “ [symbol] ”, and “ [symbol] ” are examples of the recommendations.

In addition, as illustrated in FIG. 16B, when the Japanese language test passing grade registered by the searcher in advance is the third grade, the terms related to the search term are displayed in the display unit 66, for example, in Kanji characters with furigana in hiragana characters.

By selecting a term related to the search term, it is possible to replace the search term (“ [symbol] [symbol] ”) originally input by the searcher with the selected term. After the replacement of the search term, by pressing a search button 62M, searching based on the search term as replacement is executed.

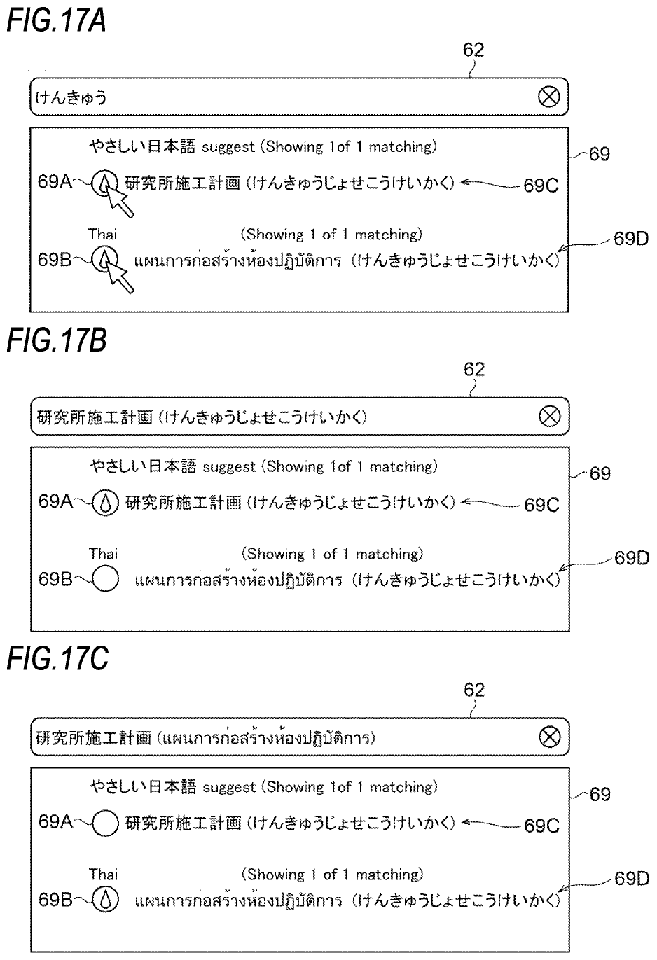

As illustrated in FIGS. 17A to 17C, the search term input unit 12 may include the search box 62. The search box 62 is provided on the display screen of the display device 60. A display unit 69 that displays assistance information related to the search term is provided in the vicinity of the search box 62. Buttons 69A and 69B are provided on the display unit 69.

It is assumed that a search term “ [symbol] ” is input to the search box 62 as illustrated in FIG. 17A.

Assistance information 69C related to the search term is displayed in the display unit 69. For example, (i) the button 69A to which “ [symbol] ” in Japanese, which is obtained by analogy with “ [symbol] ” input to the search box 62, with ruby in hiragana characters is added and (ii) the button 69B to which “ [symbol] ” in a native language with ruby in hiragana characters is added are displayed in the display unit 69.

When the searcher performs an operation of selecting the button 69A, the display screen illustrated in FIG. 17A transitions to a display screen illustrated in FIG. 17B. A search term corresponding to the selected assistance information 69C is input to the search box 62.

In addition, when the searcher performs an operation of selecting the button 69B, the display screen illustrated in FIG. 17A transitions to a display screen illustrated in FIG. 17C. A search term corresponding to the selected assistance information 69D is input to the search box 62.

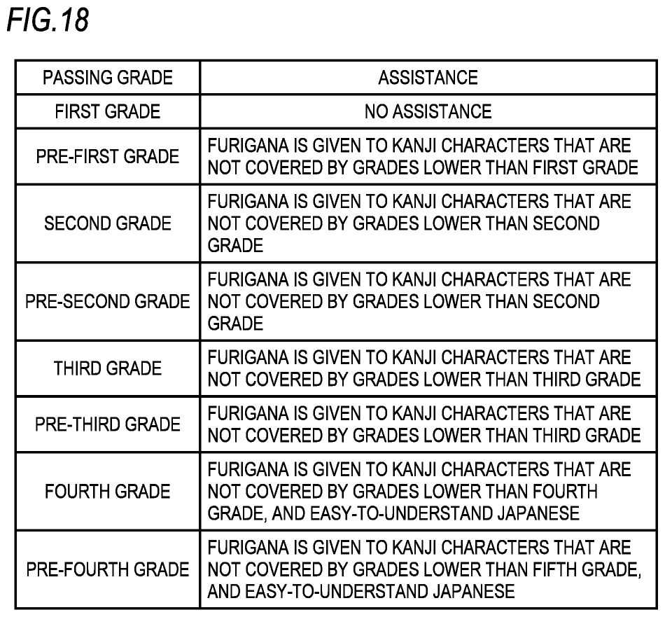

Search assistance corresponding to the language ability of the searcher may be determined, for example, as in FIG. 18.

FIG. 18 illustrates relationship between a Japanese language test passing grades and search assistance.

When the Japanese language test passing grade of the searcher is the “first grade”, no assistance is provided. Assistance information displayed in the search box 62 is displayed in a display format (Kanji characters) corresponding to the highest language ability.

When the Japanese language test passing grade of the searcher is the “pre-first grade”, assistance is provided such that Kanji characters that are not covered by grades lower than the first grade are given furigana.

When the Japanese language test passing grade of the searcher is the “second grade”, assistance is provided such that Kanji characters that are not covered by grades lower than the second grade are given furigana.

When the Japanese language test passing grade of the searcher is the “pre-second grade”, assistance is provided such that Kanji characters that are not covered by grades lower than the second grade are given furigana.

When the Japanese language test passing grade of the searcher is the “third grade”, assistance is provided such that Kanji characters that are not covered by grades lower than the third grade are given furigana.

When the Japanese language test passing grade of the searcher is the “pre-third grade”, assistance is provided such that Kanji characters that are not covered by grades lower than the third grade are given furigana.

When the Japanese language test passing grade of the searcher is the “fourth grade”, assistance is provided such that Kanji characters that are not covered by grades lower than the fourth grade are given furigana and Japanese texts are converted into easy-to-understand Japanese.

When the Japanese language test passing grade of the searcher is the “pre-fourth grade”, assistance is provided such that Kanji characters that are not covered by grades lower than the fifth grade are given furigana and Japanese texts are converted into easy-to-understand Japanese.

When the searcher is at a level where one understands a native language, assistance is provided such that ruby in the native language is given.

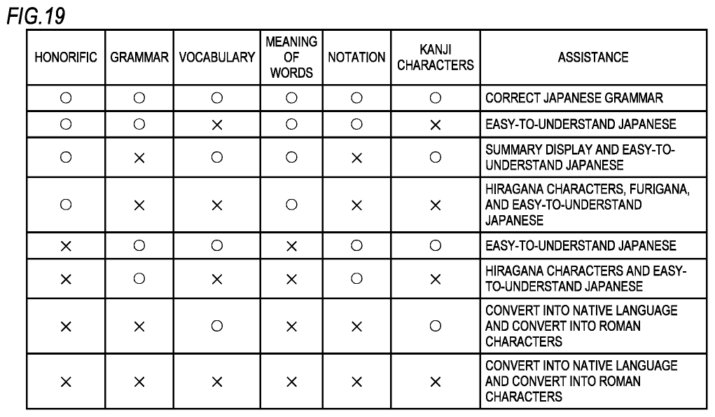

FIG. 19 illustrates a relationship between items determined in a Japanese language test and the assistance.

For each of the items “honorific”, “grammar”, “vocabulary”, “meaning of words”, “notation”, and “Kanji characters”, an item for which it is determined in the Japanese test that the searcher has a high language ability is given ∘, and an item for which it is determined in the Japanese test that the searcher has a low language ability is given x.

For example, when it is determined in the Japanese language test that the searcher has ∘ in “honorific”, x in “grammar”, x in “vocabulary”, ∘ in “meaning of words”, x in “notation”, and x in “Kanji characters”, the assistance is provided such that Japanese texts are converted into hiragana characters, are given furigana, and converted into easy-to-understand Japanese.

The assistance information related to the search term may be displayed according to the work of the searcher. For example, among terms included in the assistance information, technical terms and work-specific terms may be displayed in a display format corresponding to a level higher than a level of the language ability of the searcher (for example, the highest language ability level). Hereinafter, descriptions will be made with reference to FIG. 9.

The work information acquisition unit 15 reads the work information such as the information on the past works in which the searcher is involved (the history of works which are assigned to the searcher), the information on the process of the work being currently performed by the searcher (the information on the progress degree of the process being currently performed), and the technical terms defined in each process, from the work information storage of the database 20.

Among the terms included in the assistance information, the technical terms and work-specific terms to be displayed in the display format at a level of a language ability higher than the level of the language ability of the searcher (for example, the highest language ability) are determined based on the work information, for example, in the following manner.

### (When the Same Work is Assigned 0 Times in the Past)

As illustrated in FIG. 9, when a current work process of the searcher is “ [symbol] ”, “ [symbol] ”, “ [symbol] ”, and “ [symbol] ” are technical terms defined in the process.

When the same work is assigned to the searcher 0 times in the past, the words “ [symbol] ”, “ [symbol] ”, and “ [symbol] ” are words that the searcher has not experienced before. Therefore, the words “ [symbol] ”, “ [symbol] ”, and “ [symbol] ” are displayed in the display format corresponding to the language ability of the searcher (for example, a display format in which the document search results are converted into hiragana characters), similar to the other words.

As illustrated in FIG. 9, when the current work process of the searcher is “ [symbol] [symbol] ”, “ [symbol] ”, “ [symbol] ”, “ [symbol] ”, and “ [symbol] ” are technical terms defined in the process.

When the same work is assigned to the searcher 0 times in the past, the term “ [symbol] ” is a term that the searcher has not experienced before. However, the terms “ [symbol] ”, “ [symbol] ”, and “ [symbol] ” are terms that the searcher experiences in the process of “ [symbol] ” in the past. Therefore, the term “ [symbol] ” is displayed in the display format corresponding to the language ability of the searcher (for example, a display format in which the document search results are converted into hiragana characters), similar to other terms. On the other hand, the terms “ [symbol] [symbol] ”, “ [symbol] ”, and “ [symbol] ” are displayed in a display format (for example, Kanji characters) corresponding to a language ability higher than the language ability of the searcher (for example, the highest language ability).

As illustrated in FIG. 9, when the current work process of the searcher is “ [symbol] [symbol] ”, “ [symbol] ”, “ [symbol] ”, and “ [symbol] ” are technical terms defined in the process.

When the same work is assigned to the searcher 0 times in the past, the term “ [symbol] ” is a term that the searcher has not experienced before. On the other hand, the terms “ [symbol] ” and “ [symbol] ” are terms that the searcher experiences in the processes of “ [symbol] ” and “ [symbol] [symbol] ” in the past. Therefore, the term “ [symbol] ” is displayed in the display format corresponding to the language ability of the searcher (for example, the display format in which the document search results are converted into hiragana characters), similar to other terms. On the other hand, the terms “ [symbol] ” and “ [symbol] ” are displayed in a display format (for example, Kanji characters) corresponding to a language ability higher than the language ability of the searcher (for example, the highest language ability).

As illustrated in FIG. 9, when the current work process of the searcher is “ [symbol] [symbol] ”, “ [symbol] ”, “ [symbol] ”, “ [symbol] ”, and “ [symbol] ” are technical terms defined in the process.

When the same work is assigned to the searcher 0 times in the past, the term “ [symbol] ” is a term that the searcher has not experienced before. On the other hand, the terms “ [symbol] ”, “ [symbol] ”, and “ [symbol] ” are terms that the searcher experiences in the processes of “ [symbol] ”, “ [symbol] ”, and “ [symbol] ” in the past. Therefore, the term “ [symbol] ” is displayed in the display format corresponding to the language ability of the searcher (for example, the display format in which the document search results are converted into hiragana characters), similar to other terms. On the other hand, the terms “ [symbol] ”, “ [symbol] ”, and “ [symbol] ” are displayed in a display format (for example, Kanji characters) corresponding to a language ability higher than the language ability of the searcher (for example, the highest language ability).

As illustrated in FIG. 9, “ [symbol] ”, “ [symbol] ”, “ [symbol] ”, and “ [symbol] ” are terms specific to the current work of the searcher.

When the same work is assigned to the searcher 0 times in the past, the terms “ [symbol] ”, “ [symbol] ”, “ [symbol] ”, and “ [symbol] ” are terms that the searcher has not experienced before. Therefore, the terms “ [symbol] ”, “ [symbol] ”, “ [symbol] ”, and “ [symbol] ” are displayed in the display format corresponding to the language ability of the searcher (for example, the display format in which the document search results are converted into hiragana characters), similar to other terms. After the searcher goes through the process “ [symbol] ”, the term “ [symbol] ” becomes a term that the searcher experiences in the past. Therefore, in each of the process of “ [symbol] ” and subsequent processes, the term “ [symbol] ” is displayed in a display format (for example, Kanji characters) corresponding to a language ability higher than the language ability of the searcher (for example, the highest language ability).

### (When the Same Work is Assigned Once or More in the Past)

The technical terms and the work-specific terms illustrated in FIG. 9 are terms that the searcher experiences in the past.

Therefore, when the same work is assigned to the searcher once or more in the past, the technical terms and the work-specific terms illustrated in FIG. 9 are displayed in a display format (for example, Kanji characters) corresponding to a language ability higher than the language ability of the searcher (for example, the highest language ability).

When the same work is assigned to the searcher once or more times in the past, as the number of times increases, the number of terms displayed in the display format (for example, Kanji characters) corresponding to the language ability higher than the language ability of the searcher (for example, the highest language ability) may be increased.

In addition, the longer the time period for which the searcher is involved in the work is, the more the terms may be displayed in the display format (for example, in Kanji characters) corresponding to the language ability (for example, the highest language ability) higher than the language ability of the searcher. For example, as the number of times the searcher experiences the same work increases, among terms used for file names, the number of terms to be displayed in the display format (for example, Kanji characters) corresponding to the language ability higher than the language ability of the searcher (for example, the highest language ability) may be increased.

In addition, the technical terms and the work-specific terms to be displayed in the display format (for example, Kanji characters) corresponding to the language ability higher than the language ability of the searcher (for example, the highest language ability) may be defined for each process and each work as illustrated in FIG. 9, or may be freely registered by the searcher on the display screen illustrated in FIG. 11.

For example, when terms “ [symbol] ” and “ [symbol] ” are registered on the display screen illustrated in FIG. 11, the terms “ [symbol] ” and “ [symbol] ” may be displayed in the display format (for example, Kanji characters) corresponding to the language ability higher than the language ability of the searcher (for example, the highest language ability).

In addition, when the searcher performs an operation of storing a file in the past, terms included in the file name may be displayed in the display format (for example, Kanji characters) corresponding to the language ability higher than the language ability of the searcher (for example, the highest language ability).

For example, even when the language ability level of the searcher is at a level where one understands hiragana characters, for the file which he/she stores in the past, the terms included in the file name may be displayed in the display format (for example, Kanji characters) corresponding to the language ability higher than the language ability of the searcher (for example, the highest language ability).

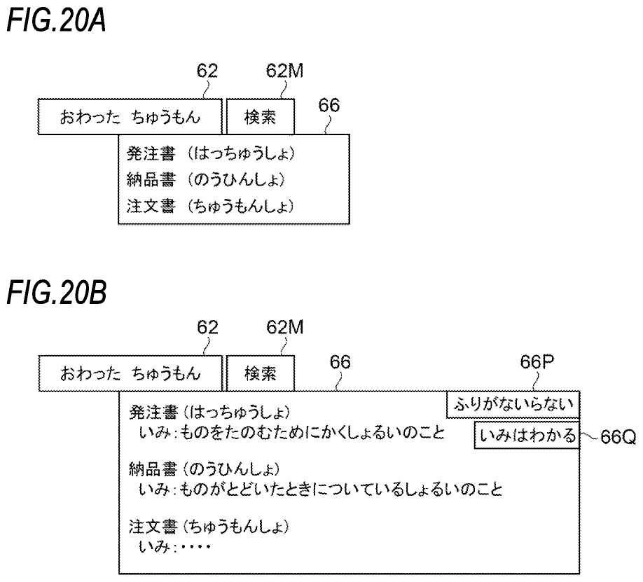

FIGS. 20A and 20B each illustrates an example in which the assistance information related to the search term is changed according to the work of the searcher. For example, the assistance information is changed according to the number of times the searcher experiences the work.

As illustrated in FIGS. 20A and 20B, the search term input unit 12 includes the search box 62. The search box 62 is provided on the display screen of the display device 60. The display unit 66 that displays the assistance information related to the search term is provided in the vicinity of the search box 62.

A search term “ [symbol] [symbol] ” is input to the search box 62, and an operation of pressing the search button 62M is performed.

When terms included in the assistance information related to the search term are related to the work that the searcher experiences, the assistance information related to the search term is changed according to the number of times the searcher experiences the work.

When the searcher has experienced the work plural times, as illustrated in FIG. 20A, the assistance information related to the search term is displayed in the display unit 66, for example, in Kanji characters with furigana in hiragana characters.

In addition, when the searcher performs the work for the first time, as illustrated in FIG. 20B, the assistance information related to the search term is displayed in the display unit 66, for example, in Kanji characters with furigana in hiragana characters, together with a commentary in hiragana characters that explains the meaning of words.

Registration buttons 66P and 66Q may be provided on the display unit 66 so that the assistance information related to the search term is changeable in next search. For example, by performing an operation of pressing the registration button 66P, the assistance information in which furigana is omitted is displayed in the display unit 66 in next search. Further, for example, by performing an operation of pressing the registration button 66Q, the assistance information in which the commentary which explains the meaning of words is omitted is displayed in the display unit 66 in next search.

The assistance information related to the search term may be generated according to a current work process of the searcher. The assistance information having a high degree of relation with the current work process of the searcher may be displayed on the display unit 66.

### (Document Search Assist Program)

Next, the operation of the document search assist apparatus 10 will be described.

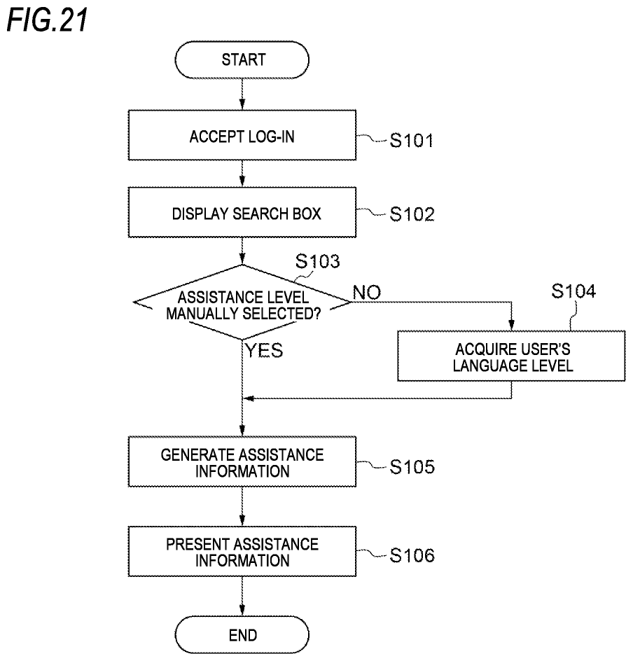

FIG. 21 is a flowchart illustrating an example of a process procedure according to the exemplary embodiment. A document search assist process is performed by the CPU 51 reading the document search assist program from the ROM 52 or the storage 54 and loading and executing the document search assist program on the RAM 53.

When an operation of starting search is performed, log-in is accepted (S101).

Next, the search box 62 is displayed on the display screen of the display device 60 (S102).

Next, it is determined whether an assistance level for input of a search term has been manually selected (S103).

When the assistance level for input of a search term has not been manually selected (S103: NO), the procedure proceeds to S104. In S104, the language ability information acquisition unit 11 reads information indicating a language ability associated with the logged-in searcher from the language ability information storage of the database 20, and acquires the information indicating the language ability of the searcher (S104).

Next, based on the information indicating the language ability of the searcher, which is obtained in S104, assistance information corresponding to the language ability of the searcher is generated (S105).

Next, the assistance information is presented (S106). For example, as illustrated in FIG. 12C, when the Japanese language test passing grade registered by the searcher in advance is the third grade, the information for assisting input of a search term is displayed in the search box 62 according to the third grade of the Japanese language test (for example, “Search” is displayed in the native language of the operator).

When it is determined that the assistance level for input of a search term has been manually selected (S103: YES), the procedure proceeds to S105.

The assistance information corresponding to the selected language ability is generated (S105).

Next, the assistance information is presented (S106). For example, as illustrated in FIG. 12B, when the searcher has selected the second grade of the Japanese language test, information for assisting input of a search term is displayed in the search box 62 according to the selected second grade of the Japanese language test (for example, “ [symbol] ” in hiragana characters) (S106).

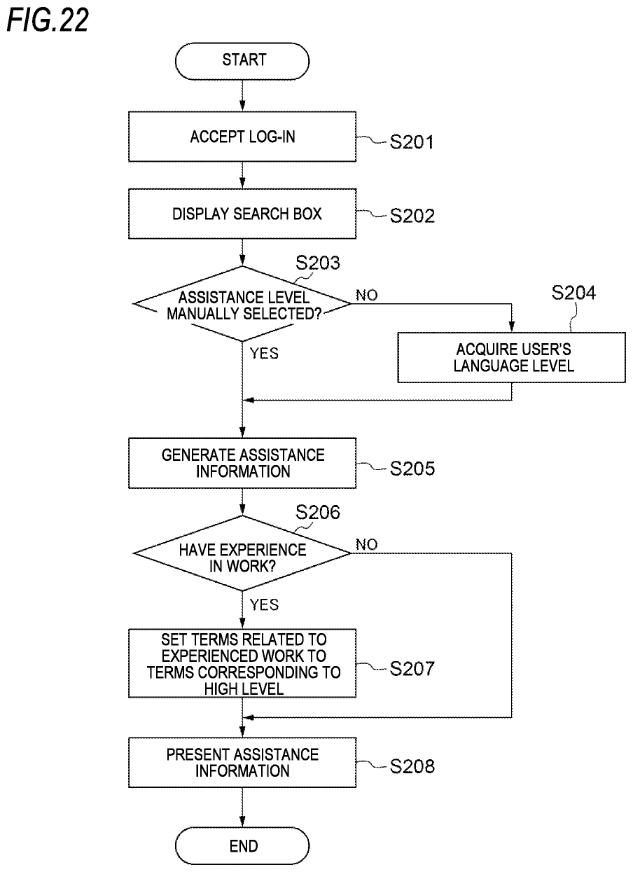

FIG. 22 is a flowchart illustrating another example of the processing procedure according to the exemplary embodiment.

When an operation of starting search is performed, log-in is accepted (S201).

Next, the search box 62 is displayed on the display screen of the display device 60 (S202).

Next, it is determined whether an assistance level for input of a search term has been manually selected (S203).

When it is determined that the assistance level for input of a search term has not been manually selected (S203: NO), the procedure proceeds to S204. In S204, the language ability information acquisition unit 11 reads information indicating a language ability associated with the logged-in searcher from the language ability information storage of the database 20, and acquires the information indicating the language ability of the searcher (S204).

Next, based on the information indicating the language ability of the searcher, which is obtained in S204, assistance information corresponding to the language ability of the searcher is generated (S205).

When it is determined that the assistance level for input of a search term has been manually selected (S203: YES), the procedure proceeds to S205.

The assistance information corresponding to the selected language ability is generated (S205).

Next, based on the work information acquired by the work information acquisition unit 15, it is determined whether the searcher has an experience in a work (S206).

When it is determined that the searcher has no experience in the work (S206: NO), the procedure proceeds to S208.

The assistance information is presented according to the language ability of the searcher. Terms related to the work, which are included in the assistance information, are also displayed according to the language ability of the searcher (S208).

In S206, when it is determined that the searcher has an experience in the work (S206: YES), the procedure proceeds to S207.

It is determined that among terms included in the assistance information, terms related to the work are to be displayed in a display format (for example, Kanji characters) corresponding to a language ability higher than the language ability of the searcher (for example, the highest language ability) (S207). The procedure proceeds to S208.

The assistance information generated in S205 is presented as it is (that is, without changing a display format) or the assistance information is presented in the display format determined in S207 when the procedure goes through S207 (S208).

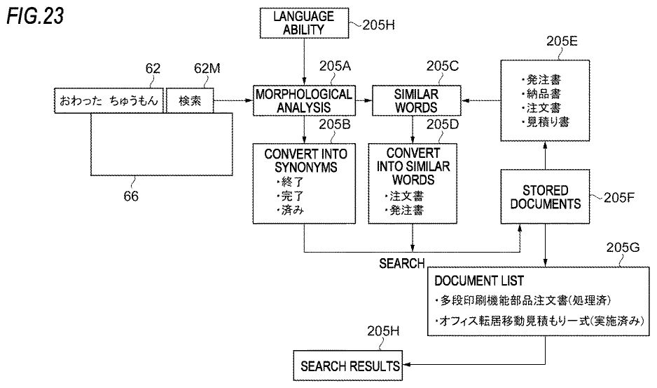

Descriptions will be made on an example of a generation process (S105 and S205) of the assistance information with reference to FIG. 23.

In the example, a word or a file name with which a target document can be retrieved is obtained by analogy with the input search term (for example, “ [symbol] [symbol] ” in hiragana characters).

The search term input unit 12 includes the search box 62. The search box 62 is provided on the display screen of the display device 60. The display unit 66 that displays the assistance information related to the search term is provided in the vicinity of the search box 62.

It is assumed that the search term “ [symbol] [symbol] ” is input to the search box 62, and an operation of pressing the search button 62M is performed. Accordingly, a morphological analysis process is performed (205A), and the word “ [symbol] ” is converted into synonyms. For example, synonyms “ [symbol] ”, “ [symbol] ”, and “ [symbol] ” are extracted (205B).

The morphological analysis process is performed, and a word “ [symbol] ” is converted into similar words. The similar words (205C) are extracted from terms included in an entity list (205E) of a document database. For example, the word “ [symbol] ” is converted into similar words “ [symbol] ” and “ [symbol] ” (205D).

A processing of searching documents (205F) stored in the document storage of the database 20 for documents including the synonyms and the similar words is executed, and a list of retrieved documents (205G) is output. It is possible to change words to be internally retrieved or the range of internal search according to the language ability of the searcher (205H). For example, when the language ability of the searcher is high, the internal search may be performed using the input search term as it is.

File names included in the retrieved document search list (205G) are displayed on the display unit 66 (205H) as the assistance information related to the search term.

The above-described process may also be implemented by a dedicated hardware circuit. In this case, the process may be executed by a single hardware circuit or plural hardware circuits.

In addition, a program that operates the document search assist apparatus 10 may be provided by a computer readable recording medium such as a universal serial bus (USB) memory, a flexible disc, or a compact disc read only memory (CD-ROM), or may be provided on-line via a network such as the Internet. In this case, the program recorded in the computer readable recording medium is generally transmitted to a memory, a storage, or the like and is stored. In addition, the program may be provided as, for example, single application software, or may be embedded as one function of the document search assist apparatus 10 in software of the apparatus.

In the above-described example, a determination is made using a Japanese language test passing grade of a searcher as a method for measuring a Japanese language ability. The method for measuring a Japanese language ability is not limited to the above-described method. Also, an application target of the invention is not limited to Japanese language. The invention is applicable to any language if display contents is changeable according to an evaluation result of a language ability. The evaluation may be made through a test or may be made by another person (for example, a teacher or a friend). Alternatively, an evaluatee may evaluate him/herself. The evaluation result may be a result indicating a comprehensive language ability or a result obtained by evaluating a particular aspect of a language ability (for example, reading or vocabulary). The evaluation result is represented in score, a grade, a level, or Pass/Fail.

The foregoing description of the exemplary embodiments of the present disclosure has been provided for the purposes of illustration and description. It is not intended to be exhaustive or to limit the present disclosure to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document search assist apparatus comprising:
a language ability information acquisition unit configured to acquire information indicating a language ability of a searcher;
a search term input unit configured to receive a search term; and
an assistance information presentation unit configured to present assistance information for input of the search term to the search term input unit, according to the language ability of the searcher, which is indicated by the information acquired by the language ability information acquisition unit.

2. The document search assist apparatus according to claim 1, wherein the assistance information comprises information related to the search term.

3. The document search assist apparatus according to claim 2, further comprising:
a work information acquisition unit configured to acquire information indicating a work of the searcher, wherein
the assistance information presentation unit presents a term related to the search term according to the work of the searcher, which is indicated by the information acquired by the work information acquisition unit.

4. The document search assist apparatus according to claim 3, wherein
the assistance information presentation unit presents a term related to the work of the searcher, which is indicated by the information acquired by the work information acquisition unit, among terms included in the assistance information related to the search term, in a presentation format corresponding to a language ability higher than the language ability of the searcher, which is indicated by the information acquired by the language ability information acquisition unit.

5. The document search assist apparatus according to claim 4, wherein
the work information acquisition unit acquires information on a past work in which the searcher is involved, and
the assistance information presentation unit presents a term related to the past work indicated by the information acquired by the work information acquisition unit, among the terms included in the assistance information related to the search term, in the presentation format corresponding to the language ability higher than the language ability of the searcher, which is indicated by the information acquired by the language ability information acquisition unit.

6. The document search assist apparatus according to claim 5, wherein
the assistance information presentation unit presents the assistance information related to the search term such that the longer a time period for which the searcher is involved the work is or the more the number of times the searcher experiences the work is, the more words are presented in the presentation format corresponding to the language ability higher than the language ability of the searcher, which is indicated by the information acquired by the language ability information acquisition unit.

7. The document search assist apparatus according to claim 3, wherein
the work information acquisition unit acquires information on a file stored by the searcher, and
the assistance information presentation unit presents a term related to the file stored by the searcher, which is indicated by the information acquired by the work information acquisition unit, among the terms included in the assistance information related to the search term, in a presentation format corresponding to the language ability higher than the language ability of the searcher, which is indicated by the information acquired by the language ability information acquisition unit.

8. The document search assist apparatus according to claim 4, wherein
the work information acquisition unit acquires information on a file stored by the searcher, and
the assistance information presentation unit presents a term related to the file stored by the searcher, which is indicated by the information acquired by the work information acquisition unit, among the terms included in the assistance information related to the search term, in the presentation format corresponding to the language ability higher than the language ability of the searcher, which is indicated by the information acquired by the language ability information acquisition unit.

9. The document search assist apparatus according to claim 5, wherein
the work information acquisition unit acquires information on a file stored by the searcher, and
the assistance information presentation unit presents a term related to the file stored by the searcher, which is indicated by the information acquired by the work information acquisition unit, among the terms included in the assistance information related to the search term, in the presentation format corresponding to the language ability higher than the language ability of the searcher, which is indicated by the information acquired by the language ability information acquisition unit.

10. The document search assist apparatus according to claim 6, wherein
the work information acquisition unit acquires information on a file stored by the searcher, and
the assistance information presentation unit presents a term related to the file stored by the searcher, which is indicated by the information acquired by the work information acquisition unit, among the terms included in the assistance information related to the search term, in the presentation format corresponding to the language ability higher than the language ability of the searcher, which is indicated by the information acquired by the language ability information acquisition unit.

11. The document search assist apparatus according to claim 1, wherein
the assistance information presentation unit presents the assistance information to the search term input unit, according to the language ability of the searcher, which is indicated by the information acquired by the language ability information acquisition unit.

12. The document search assist apparatus according to claim 11, further comprising:
a language ability selection unit configured to select the language ability of the searcher, wherein
the assistance information presentation unit presents the assistance information to the search term input unit, according to the language ability of the searcher, which is selected by the language ability selection unit.

13. A non-transitory computer readable medium storing a program that causes a computer to execute a document search assistant process comprising:
acquiring information indicating a language ability of a searcher;
receiving a search term; and
presenting assistance information for input of the search term, according to the language ability of the searcher, which is indicated by the acquired information.

14. A document search assist system comprising:
a language ability information acquisition unit configured to acquire information indicating a language ability of a searcher;
a search term input unit configured to receive a search term; and
an assistance information presentation unit configured to present assistance information for input of the search term to the search term input unit, in a presentation formation corresponding to the language ability of the searcher, which is indicated by the information acquired by the language ability information acquisition unit.
